(19) United States
(12) Patent Application Publication
(10) Pub. No.: US 2008/0243560 A1
(43) Pub. Date: Oct. 2, 2008

(54) VIRTUAL CEMETERY WITH CONSECRATION

(76) Inventor: Christopher Barendt, Devon (GB)

Correspondence Address: MESMER & DELEAULT, PLLC, 1 NEW HAMPSHIRE AVE., SUITE 125, PORTSMOUTH, NH, 03801, US

(21) Appl. No.: 11/695,031

(22) Filed: Apr. 1, 2007

(51) Int. Cl. G06Q 10/00

(52) U.S. Cl. 705/5

(57) ABSTRACT

A method for making an on-line virtual cemetery wherein a customer can construct and display a web site for the departed having bibliographic information, the method having the steps of an online user operating an computer application for selecting a computer-generated environmental setting of the grave site; obtaining consecration of the site by desired clergy; and recording and displaying video messages.

### BACKGROUND

1. Field of the Invention

The invention is in the field of online memorials for departed persons.

2. Description of the Related Art

We live in a very mobile society. People are traveling further and more frequently and often find themselves living far away from family and friends. Communication using computers and the Internet metaphorically shrinks the distances between us, and makes the world seem smaller.

Death is a time for grieving, when we mark the deceased's journey to his or her greater reward and try to keep their stories alive in our memories. Traditionally, friends and family could gather at the gravesite in the nearby cemetery to be closer to the departed. Nowadays, this is often impossible due to the physical distances between us.

Our funerary traditions go back thousands of years. However, they have not kept pace with the information age. There is a need to use modern communication technology in concert with our ancient funerary traditions to make those cherished traditions more available today to survivors who find themselves far away.

One solution that has been tried is disclosed in Patent Abstracts of Japan Pub. No 2001-297150 (the '150 application), which is not admitted to being prior art by its mention in this Background section. The '150 application discloses a memorial in the form of a monument or tree, for example, equipped with a terminal to an intranet server over a LAN to audio and video recordings related to the departed. Although modern communications technology is used, the viewer must be physically at the gravesite to use it.

Another solution is disclosed in PCT application Pub. No. WO 01/29736 (the '736 application), which is not admitted to being prior art by its mention in this Background section. The '736 application discloses a method of gathering personal information, commemorations, and images of the departed into a central database accessible by anyone online. However, the '736 application does not have any facility for generating a gravesite environment or consecrating the site.

Another solution is disclosed in U.S. App. Pub. No. 2004/0107216 (the '216 application), which is not admitted to being prior art by its mention in this Background section. The '216 application mentions a system and method for creating an online gravesite, entering bibliographic text and image information about the departed, and scheduling events. The '216 application also mentions a facility for broadcasting a funeral live and making recorded version available for future viewing. However, the '216 application does not mention selecting a gravesite environment or consecrating the site. Viewing an online gravesite without the surrounding environment does not honor our ancient funerary traditions of visiting the departed at the grave.

What is needed, therefore, is an online virtual cemetery that provides a desired environment for the memorial, and provides the opportunity for consecration by a chosen religion.

### SUMMARY

The invention is an online virtual cemetery that satisfies the need for provides a desired environment for the memorial, and provides the opportunity for consecration by a chosen religion. The invention is a method for making an on-line virtual cemetery wherein a customer can construct and display a web site for the departed having bibliographic information, the method comprising the steps of an online user operating an computer application for selecting a computer-generated environmental setting of the grave site; obtaining consecration of the site by desired clergy; and recording and displaying video messages. These and other features, aspects, and advantages of the present invention will become better understood with regard to the following description, claims, and accompanying drawings.

### DRAWINGS

FIG. 1 is a process flow chart showing the registration process according to the present invention.

FIG. 2 is a process flow chart showing the login process according to the present invention.

FIG. 3 is a process flow chart showing the process of buying and reserving a grave plot according to the present invention.

FIG. 4 is a process flow chart showing the process of activating a plot according to the present invention.

FIG. 5A is a process flow chart showing the first part of the process for customizing a plot according to the present invention.

FIG. 5B is a process flow chart showing the second part of the process for customizing a plot according to the present invention.

FIG. 6 is a process flow chart showing details of the consecration process.

### DESCRIPTION

The invention is a method for making an on-line virtual cemetery wherein a customer can construct and display a web site for the departed having bibliographic information, the method comprising the steps of an online user operating an computer application for selecting a computer-generated environmental setting of the grave site; obtaining consecration of the site by desired clergy; and recording and displaying video messages.

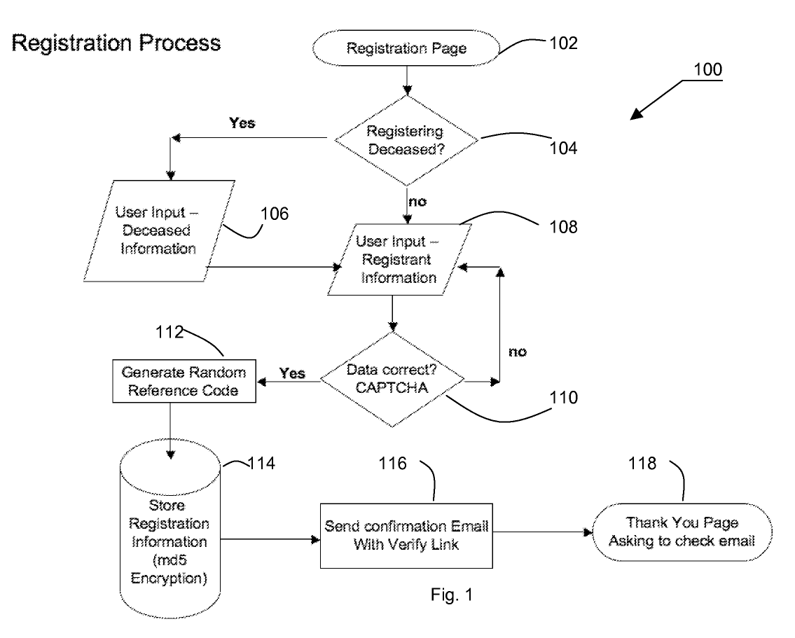

Turning to FIG. 1, a user first enters the system by going through the registration process 100. The user visits the registration page 102 of an interactive computer application on the Web or on a standalone computer. The page queries whether the user is registering a deceased person 104. If yes, the user inputs information about the deceased 106. If no, the page queries the user to input the user's registrant information 108. The application will decide if the information is correct 110. Optionally, the application will also verify that a human is making the query and not a computer using CAPTCHA, the trademark initialization a completely automated public Turing test to tell computers and humans apart. The trademark is owned by Carnegie Mellon University.

If the user passes the test, the application will generate a random reference code 112 and store the registration information 114. Preferably, the information will be encrypted by MD5 encryption.

The application will send a confirmation e-mail with a verification link 116. The application then send the user to a thank-you page with a request that the user checks its e-mail 118.

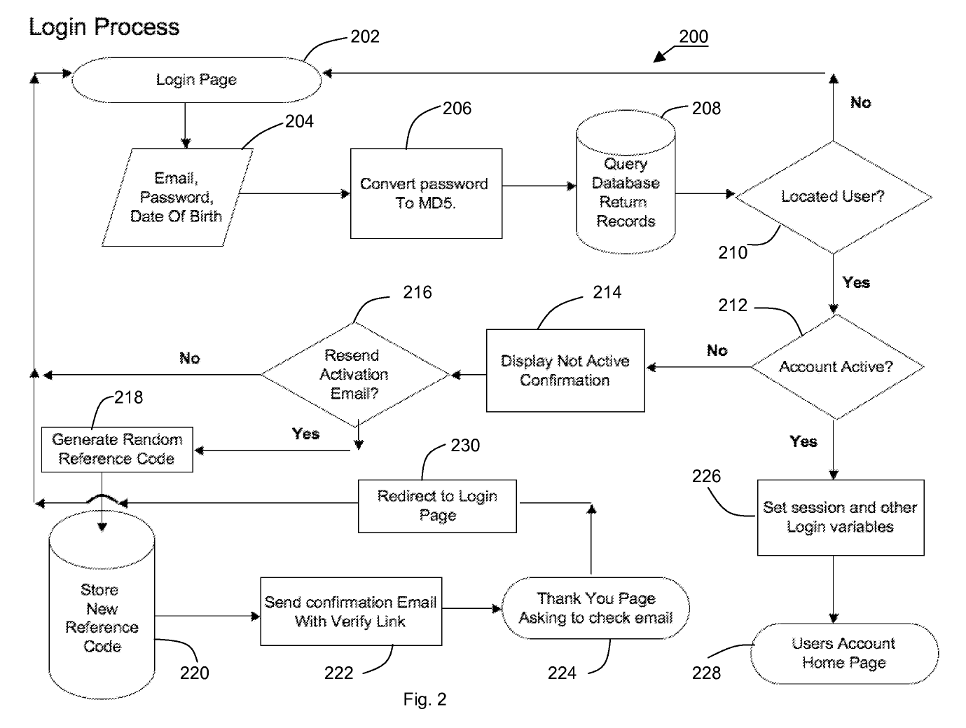

The process flow chart in FIG. 2 describes how a user will login to the application 200 after registering according to the process of FIG. 1. The user goes to the login page 202 of the computer application, and enters login information 204, such as e-mail address, password, and/or date of birth. The information is encrypted 206 preferably with MD5. The application queries the database 208.

The application decides whether it has located the user 210. If no, then the user is sent back to the login page 202. If yes, then application decides whether the user's account is active 212. If yes, the application sets session and other login variables 226. The application then sends the user to the user's account home page 228.

If the application decides the user's account is not active 212, then the application displays the not active confirmation 214. At that point, the application queries the user whether to resend the activation e-mail 216. If the answer is no, then the user is sent back to the login page 202. If yes, the application generates a random reference code 218 and stores the new reference code in the database 220, which is analogous to the original storing step 114. The application sends a confirmation e-mail with verification link 222, and then displays a thank-you page and a request to check e-mail 224. The user is then redirected 230 to the login page 202.

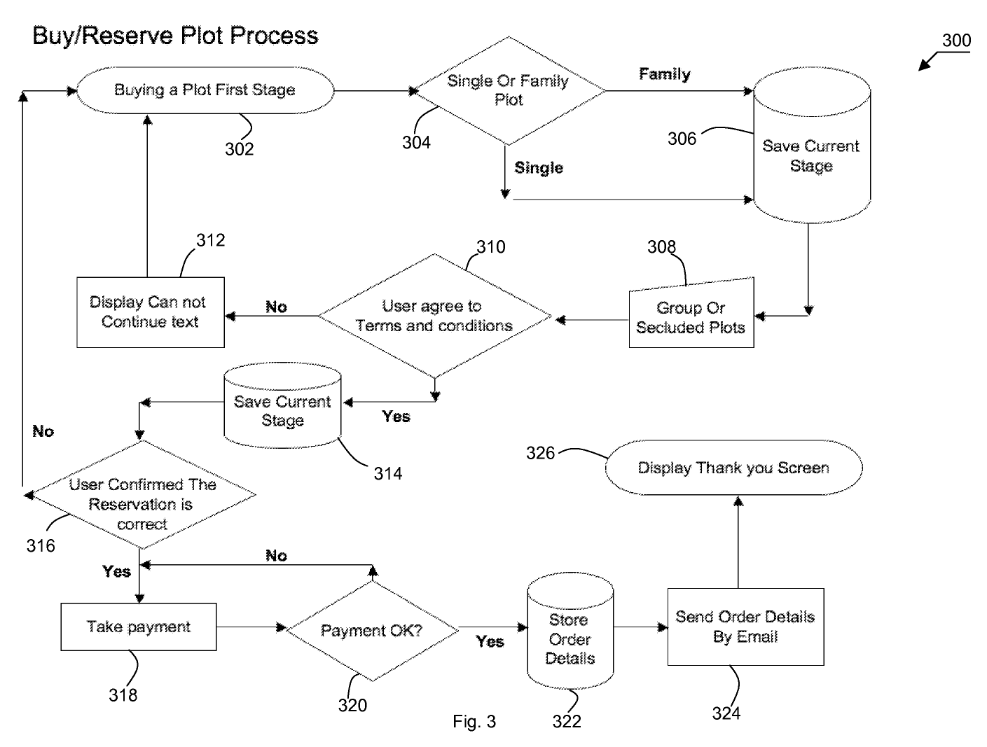

The process flow chart of FIG. 3 describes the process of reserving and buying a virtual cemetery plot 300. The user starts at the buying a plot screen 302, and is directed to decide whether to buy a single or family plot 304. The information is stored 306. The user then selects between group plots or secluded plots and receives the terms and conditions 308. The user must decide whether to agree to the terms and conditions 310. If no, then the application tells the user it cannot continue 312. If yes, then the application saves the current stage 314.

Then application then asks the user whether the reservation information is correct 316. If no, then the user must start again. But if the answer is yes, then the application starts the online payment system 318. The application determines whether the payment is accepted 320. If not, then the user must start the payment cycle again. If yes, then the application stores the order details 322. The order details are sent to the user by e-mal 324, and the application displays a thank you screen 326.

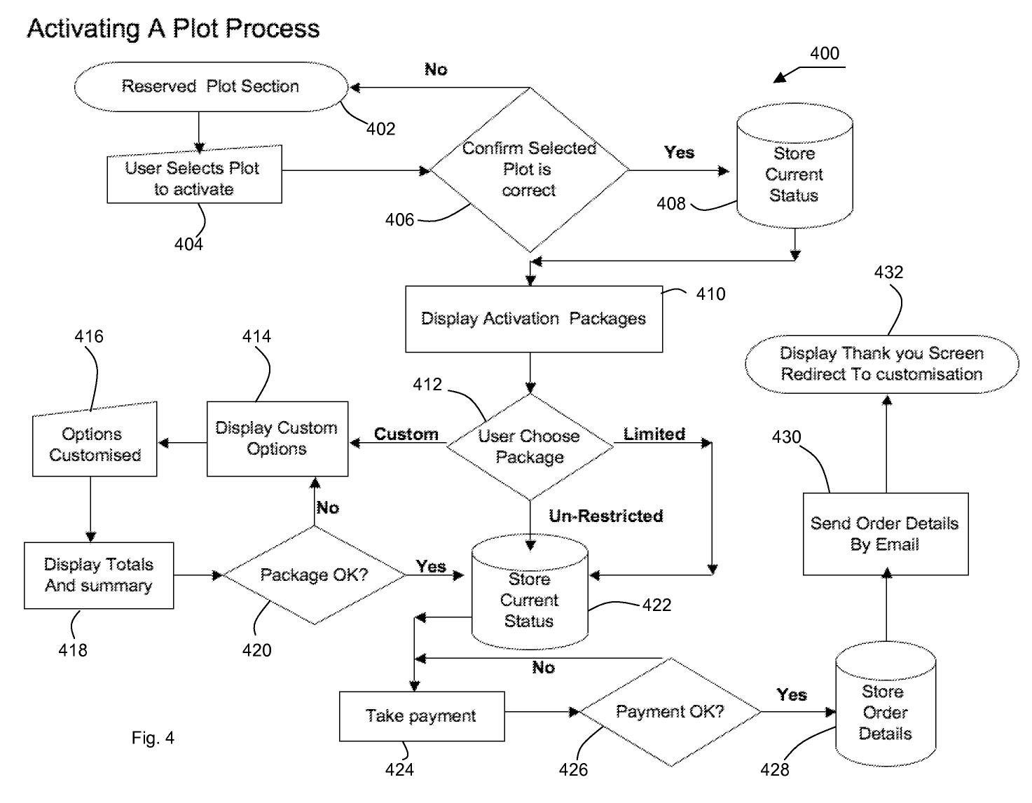

The process flow chart of FIG. 4 describes the process of activating a plot 400 after one has bought and reserved a plot 300. One starts with a reserved plot section 402, at which the user selects a plot to activate 404. The computer application will ask the user to confirm that the selected plot is correct 406. If yes, the application stores the current status 408, and displays available activation packages 410.

The user can choose between custom, limited, and unrestricted packages. If the choices are limited or unrestricted, the application stores the current status 422, and goes to a take payment process 424. If the choice is for a custom package, the application displays custom options 414. The custom option is chosen, and the application displays totals and summary 418. The user decides whether the package is acceptable 420. If yes, the application stores the current status 422 and goes to a take payment process 424.

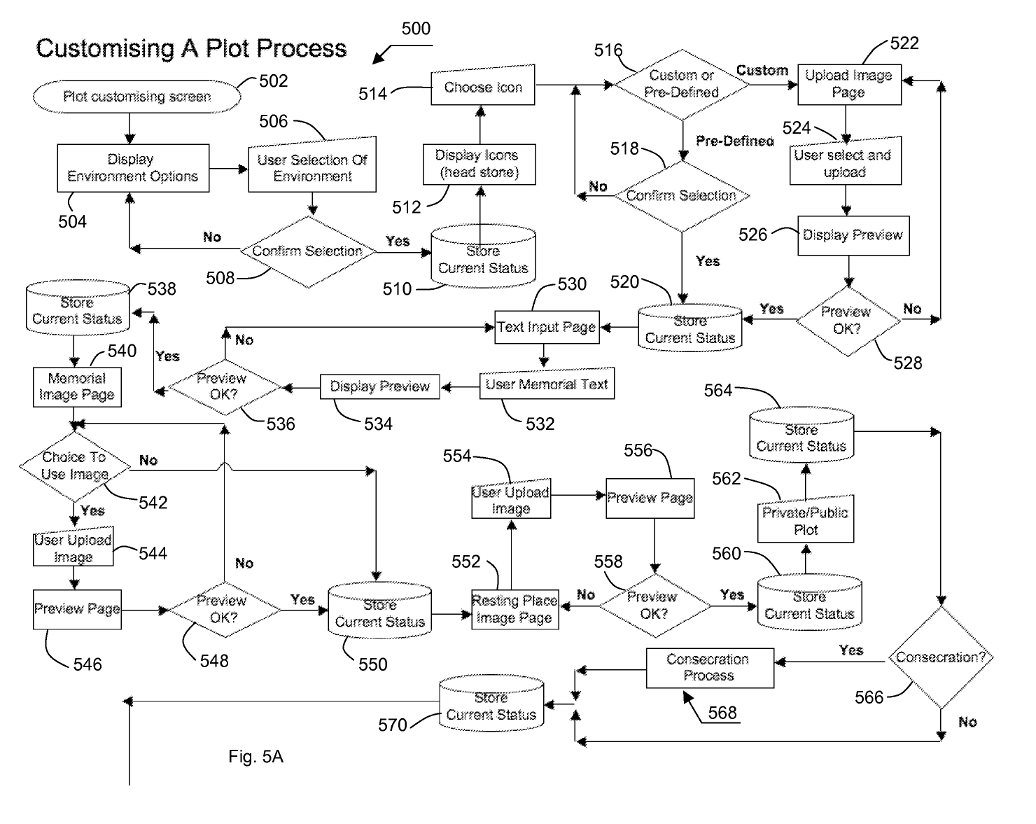

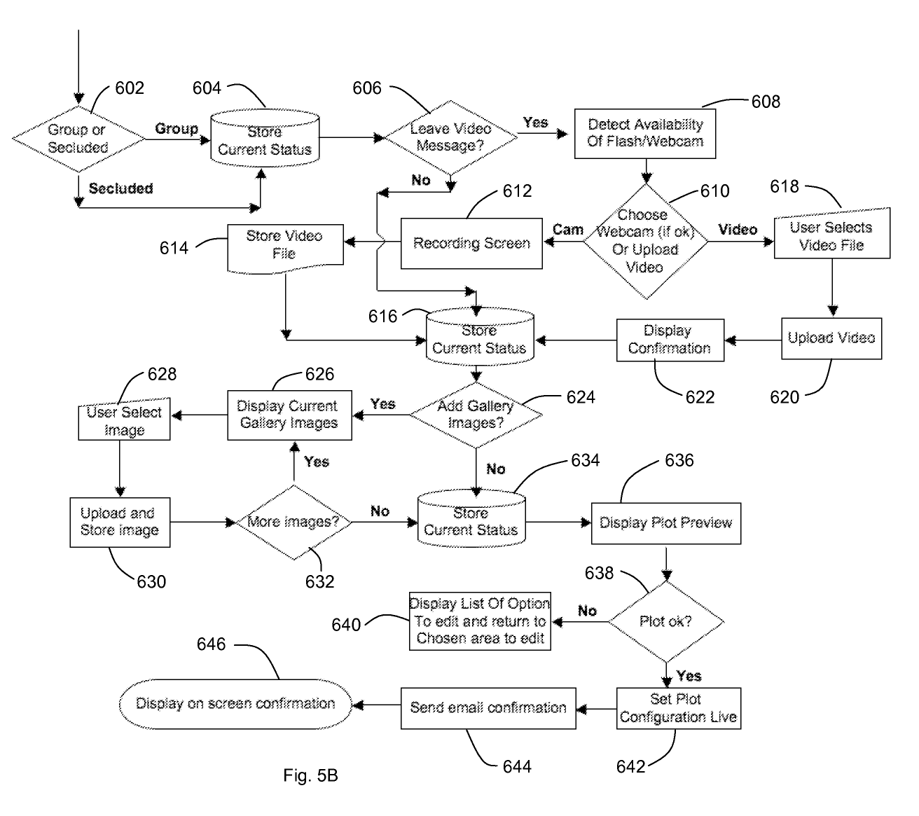

If the payment is accepted 426, the application stores order details 428 and sends the order details to the user 430 by e-mail. The application displays a thank-you screen and redirects the user to the customization process 500 starting on FIG. 5A.

The process flow chart of FIG. 5A and FIG. 5B describe the process of customizing a plot 500. First, the user sees the application's plot customizing screen 502, and the environmental options are displayed 504. The environmental options refer to the physical environment surrounding the gravesite, which will be generated by computer. In one embodiment, the user can choose options that result in a virtual-reality type of environment. Particularly, the physical environment can be an animated, simulated three-dimensional space with matched audio tracks. The customer and later users of the site would be able move to different positions within the site. For example, the site could be next to a beach, and a user would see waves moving on a shore and sea birds flying overhead. The user could travel from being close to a headstone to close to the water's edge. Over time, the sun would set. The images could be completely drawn by computer, or could use photos of real places. The site would provide as much as a sense of place as can be imagined with a computer screen and speakers.

The user selects the desired environment 506, and confirms the selection 508. If correct, the application stores the status 510 and displays icons for choosing a virtual headstone 512.

The user chooses an icon 514. For images and writings on the headstone, the application asks the user whether it will be custom or predefined 516. If pre-defined, the application will confirm the selection with the user 518 and store the current status 520. If the user selects a custom image, the user is directed to the upload image page 522. The user selects and uploads the desired image 524. The application displays a preview 526. The user determines whether the preview is acceptable 528. If yes, the application stores the status 520 and directs the user to the text input page 530.

The user inputs memorial text 532. The application displays a preview 534. The user determines whether the preview is acceptable 536. If yes, the application stores the status 538 and directs the user to the memorial text input page 540.

The user will decide whether to use a memorial image 542. If no, the application stores the current status 550 and directs the user to a resting place image page 552. If yes, the user is prompted to upload the image 544, followed by the preview page 546. The user will decide whether the preview is acceptable 548. If yes, the application stores the current status 550 and directs the user to a resting place image page 552.

The user is prompted to upload a resting place image 554. The application presents the preview page 556. The user determines whether the preview is acceptable 558. If yes, then the application stores the current status. The application then completes the plot as a public or private plot 562 and stores the current status 564. In other embodiments, these choices could be rearranged or even combined with the choice of environmental options 504.

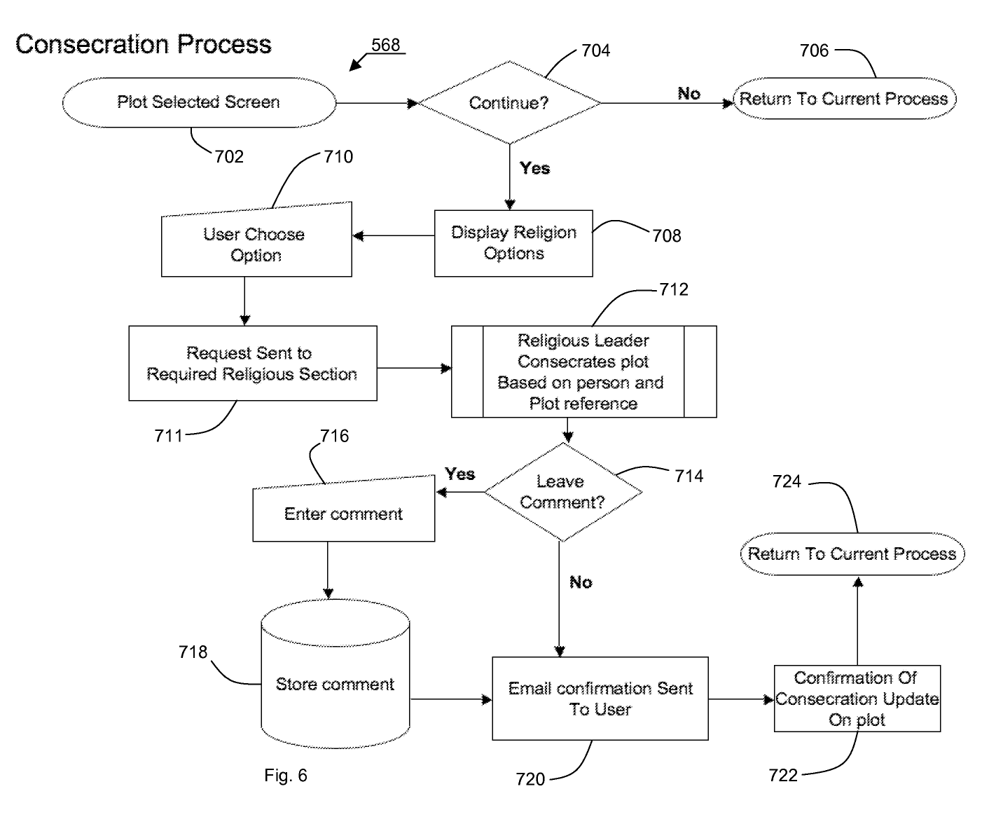

The user will be prompted to choose whether to have the site consecrated 566. If no, then the application stores the current status 570. If yes, then the user is directed to the consecration process 568 described more fully in FIG. 6.

After consecration or deciding not to consecrate, the user will decide between a group and secluded site 602, and store the current status 604. The user must then determine whether to leave a video message 606. If no, the application stores the current status 616. If yes, the application detects the availability of a flash/web cam 608. The user chooses whether to record a message on Web cam or to upload video 610. If recording on a Web cam, the application goes to the recording screen 612. Then the application stores the video file 614 and stores the current status 616. If uploading video, the user selects a video file 618 and uploads the video 620. The application displays a confirmation page 622 and stores the current status 616.

The user must then decide whether to add gallery images. If no, the application stores the current status 634 and displays the plot preview 636. If yes, the application displays the current images. The user selects an image 628, and uploads and stores the image 630. The application asks if there are more images 632. If yes, the user is directed to the display current gallery images screen 626. If no, the application stores the current status and displays the plot preview page 636.

The user reviews the plot and determines whether it is acceptable 638. If no, the application displays the list of options to edit and directs the user to the chosen area to edit 640. If yes, the application sets the plot configuration as “live” 642 and sends an e-mail confirmation to the user 644. The application displays an on screen confirmation 646.

The process flow chart of FIG. 6 describes the consecration process 568. The application shows a plot selected screen 702 and asks the user whether to continue 704. If no, then the user is returned to the process from where the user came 706.

If yes, the application displays religion options 708. The user chooses an option 710, and the application sends a request to a representative of the requested religion 711. The representative then consecrates the plot based on the user's preferences 716. The application asks the representative whether he or she would like to leave a comment 714. If no, then the application sends an e-mail confirmation to the user 720. If yes, the representative enters a comment 716, which is stored 718. Then the application sends confirmation to the user 720. The confirmation of consecration of the plot is updated 722, and the user is redirected to the process from which the user came 724.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. A method of operating an on-line virtual cemetery wherein a customer can construct and display a web site for the departed having bibliographic information, the method comprising the steps of an online user operating an computer application:
selecting a computer-generated environmental setting of the grave site;
obtaining consecration of the site by desired clergy; and
recording and displaying video messages.

2. The method of claim 1, the step of selecting a computer-generated environmental setting comprising the steps of:
reserving a plot; and
customizing a plot.

3. The method of claim 2, the reserving step comprising the steps of:
choosing a single plot versus a family plot; and
choosing a group plot versus a secluded plot.

4. The method of claim 2, the customizing step comprising the steps of:
selecting a computer-generated physical environments
selecting a custom or pre-defined headstone design; and
providing user memorial text for a memorial Web site.

5. The method of claim 4 wherein the selecting a computer-generated physical environment step is selecting an animated three-dimensional environment with sound within which a user can navigate to view from different positions.

6. The method of claim 4, the customizing step further comprising the steps of:
providing a memorial image of a departed person;
providing a resting place image; and
providing an option to have the site consecrated.

7. The method of claim 4, the customizing step further comprising the steps of:
providing an option to leave a video message;
providing an option to add images to the site; and
providing an option to approve the plot site.

8. The method of claim 6 further comprising the step of consecrating the site, the consecrating step comprising the steps of:
the user selecting a religion;
sending a request for consecration to a representative of the selected religion;
consecrating the site by the representative based on user and plot preferences;
notifying the user that consecration has occurred.

9. The method of claim 1, further comprising the steps of:
logging on to the computer program; and
registering a person who has departed, the registering step comprising:
inputting information about the departed;
verifying the information is from a human using a completely automated public Turing test to tell computers and humans apart;
encrypting the registration information; and
storing the registration information.

10. The method of claim 9, wherein the encrypting is using MD5 encryption.

11. A virtual cemetery comprising:
an interactive computer application having inputs enabling a user to design a cemetery plot Web site with computer-generated environmental surroundings for a departed person; and
a cemetery plot Web site for a departed person made with input from the interactive computer application and user inputs comprising:
an image of the plot in its environmental surroundings; and
an image of the departed person.

12. The virtual cemetery of claim 11, the cemetery plot Web site further comprising:
audio content; and
video content comprising an animated three-dimensional environment matched with the audio content within which a user can navigate to view from different positions.

13. The virtual cemetery of claim 11, further comprising a means for requesting consecration of the cemetery plot Web site, the means comprising:
the user registers a decision to consecrate with the interactive computer application;
the application displays religion consecration options to user;
the user chooses a religion consecration option;
the application transmits a signal to a representative of the chosen religion that consecration has been requested;
the religion representative consecrates the virtual cemetery Web site based on the user's choices;
the religion representative transmits a signal to the computer application indicating the site has been consecrated; and
the application transmits a signal to the user that the site has been consecrated.

14. A virtual cemetery comprising an interactive memorial Web page for a departed person have an animated, simulated three-dimensional physical environment matched with audio content and that enables a user to navigate to different positions within the three-dimensional environment.

15. The virtual cemetery of claim 14, further comprising an interactive computer application that enables users to design the memorial Web page.

16. The virtual cemetery of claim 15, further comprising a means for requesting consecration of the cemetery plot Web site.

17. The virtual cemetery of claim 16, the means for requesting consecration comprising:
the user registers a decision to consecrate with the interactive computer application;
the application displays religion consecration options to user;
the user chooses a religion consecration option;
the application transmits a signal to a representative of the chosen religion that consecration has been requested;
the religion representative consecrates the virtual cemetery Web site based on the user's choices;
the religion representative transmits a signal to the computer application indicating the site has been consecrated; and
the application transmits a signal to the user that the site has been consecrated.
